(19) United States
(12) Patent Application Publication
(10) Pub. No.: US 2021/0308542 A1
(43) Pub. Date: Oct. 7, 2021

(54) Golf Clip Multi-Tool Apparatus

(71) Applicant: Leonard Parra, Nampa, ID (US)

(72) Inventor: Leonard Parra, Nampa, ID (US)

(21) Appl. No.: 16/841,281

(22) Filed: Apr. 6, 2020

(51) Int. Cl. A63B 57/50; A63B 57/35; A63B 57/30; B67B 7/16; B67B 7/44

(52) U.S. Cl. CPC A63B 57/50; A63B 57/35; B67B 7/44; B67B 7/16; A63B 57/353

(57) ABSTRACT

A golf clip multi-tool apparatus for having a multi-functional and convenient golf tool includes a clip top and a clip bottom. The clip bottom is curved to conform to the curvature of the user's head from the user's temple towards the top of the user's head. A clip top front end and a clip bottom front end are pointed for use as a divot repair tool. A pivot rod is coupled to the clip top and the clip bottom. The clip top and the clip bottom pivot between an open position and a closed position. A pivot spring is coupled around the pivot rod. The pivot spring contacts a clip top inner side and a clip bottom inner side to bias the clip top and the clip bottom to the closed position. The apparatus attaches to the user's hat and may additionally support the user's hair and sunglasses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to golf tools and more particularly pertains to a new golf tool for having a multi-functional and convenient golf tool.

### (2) Description of Related Art Including Information Disclosed Under 37 CFR 1.97 and 1.98

The prior art relates to golf tools for repairing divots and marking balls. Existing devices may have attachment means to hats and other clothing but do not offer a strong support to clip to also secure hair or sunglasses. Furthermore, existing tools are not ergonomically designed to be worn comfortably against the user's head.

### BRIEF SUMMARY OF THE INVENTION

An embodiment of the disclosure meets the needs presented above by generally comprising a clip top having a clip top back end, a clip top front end, a clip top outer side, and a clip top inner side. The clip top front end is pointed and configured for use as a divot repair tool. A clip bottom has a clip bottom back end, a clip bottom front end, a clip bottom outer side, and a clip bottom inner side. The clip bottom is curved to conform to the curvature of the user's head from the user's temple towards the top of the user's head. The clip bottom front end is pointed and configured for use with the clip top as a divot repair tool. A pivot rod is coupled to the clip top and the clip bottom. The pivot rod is pivotably coupled to a pair of pivot ears of each of the clip top inner side and the clip bottom inner side proximal the clip top back end and the clip bottom back end, respectively. The clip top and the clip bottom pivot between an open position with the clip top back end adjacent the clip bottom back end and a closed position with the clip top inner side adjacent the clip bottom inner side. A pivot spring is coupled around the pivot rod. The pivot spring contacts the clip top inner side and the clip bottom inner side to bias the clip top and the clip bottom to the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a golf clip multi-tool apparatus according to an embodiment of the disclosure.

FIG. 2 is a rear elevation view of an embodiment of the disclosure.

FIG. 3 is a side elevation view of an embodiment of the disclosure.

FIG. 4 is a top plan view of an embodiment of the disclosure.

FIG. 5 is a bottom plan view of an embodiment of the disclosure.

FIG. 6 is an in-use view of an embodiment of the disclosure.

### DETAILED DESCRIPTION OF THE INVENTION

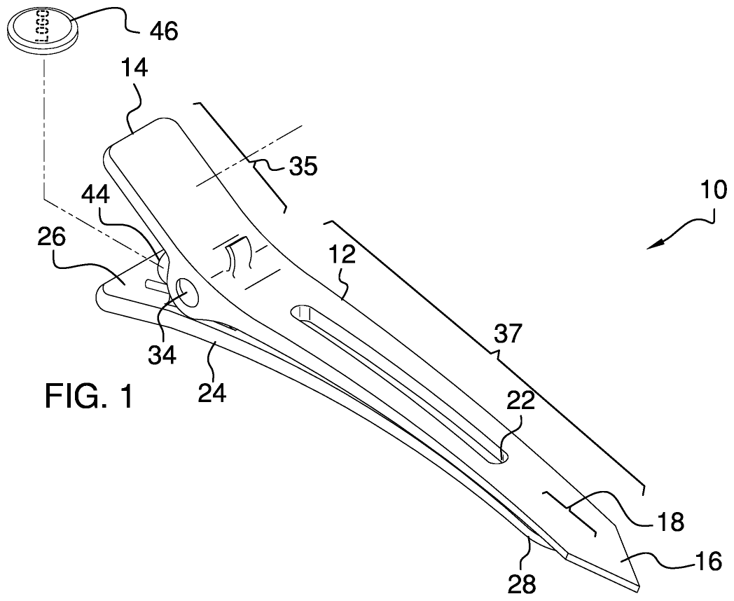

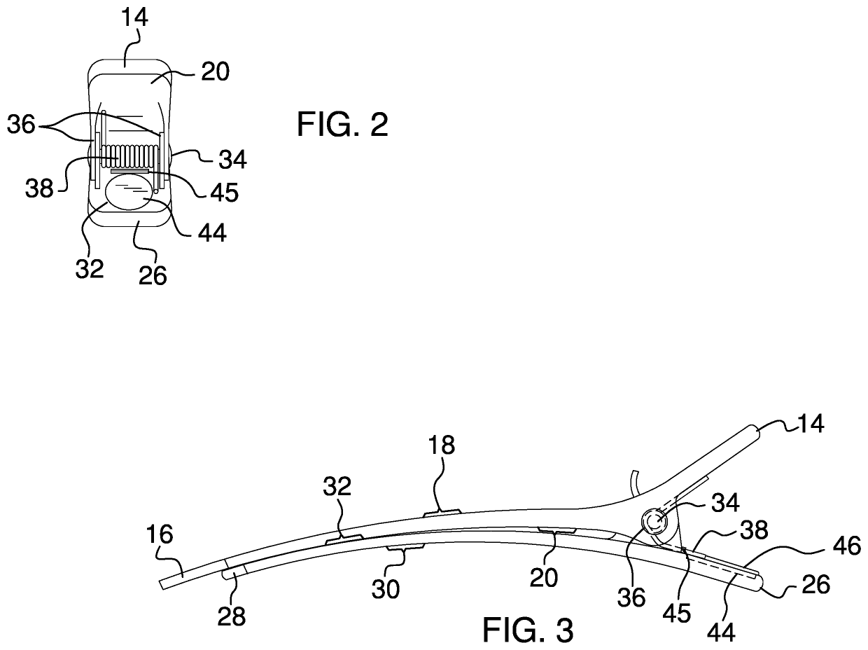

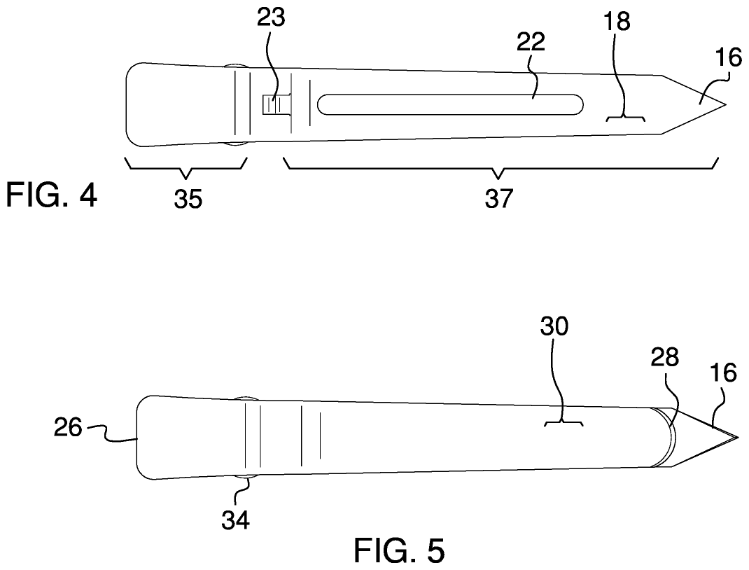

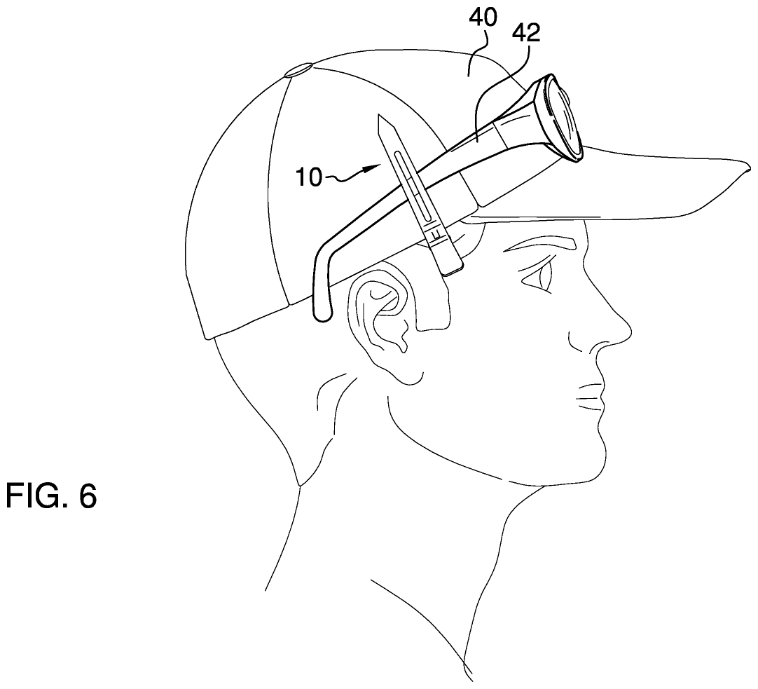

With reference now to the drawings, and in particular to FIGS. 1 through 6 thereof, a new golf tool embodying the principles and concepts of an embodiment of the disclosure and generally designated by the reference numeral 10 will be described.

As best illustrated in FIGS. 1 through 6, the golf clip multi-tool apparatus 10 generally comprises a clip top 12 having a clip top back end 14, a clip top front end 16, a clip top outer side 18, and a clip top inner side 20. The clip top front end 16 is pointed and configured for use as a divot repair tool. The clip top 12 may have a stencil aperture 22 extending from the clip top outer side 18 through the clip top inner side 20. The stencil aperture 22 may be an elongated obround shape configured to be positioned over a golf ball and to receive a marker to create an identification mark on the golf ball. A bottle opener tab 23 may be coupled to the clip top 12. The bottle opener tab 23 may be coupled to the clip top outer side 18 and is configured to open bottles.

A clip bottom 24 has a clip bottom back end 26, a clip bottom front end 28, a clip bottom outer side 30, and a clip bottom inner side 32. The clip bottom 24 may be curved to conform to the curvature of the user's head from the user's temple towards the top of the user's head so that it may be comfortably worn inside the user's hat.

A pivot rod 34 is coupled to the clip top 12 and the clip bottom 24. The pivot rod 34 may be pivotably coupled to a pair of pivot ears 36 of each of the clip top inner side 20 and the clip bottom inner side 32 proximal the clip top back end 14 and the clip bottom back end 26, respectively. The clip top 12 and the clip bottom 24 pivot between an open position with the clip top back end 14 adjacent the clip bottom back end 26 and a closed position with the clip top inner side 20 adjacent the clip bottom inner side 32. The clip top 12 may comprise a back portion 35 and a front portion 37. The back portion 35 is planar and extends from the clip top back end 14 to the pivot ears 36 of the clip top inner side 20 and the front portion 37 extends from the back portion 35 to the clip top front end 16. The clip top front portion 37 may have a curvature conforming to the curvature of the clip bottom 24.

A pivot spring 38 is coupled around the pivot rod 34. The pivot spring 38 contacts the clip top inner side 20 and the clip bottom inner side 32 to bias the clip top 12 and the clip bottom 24 to the closed position. The pivot spring 38 applies sufficient force to clamp the apparatus around a user's hat 40 and a user's sunglasses 42. The apparatus 10 may also be applied to secure a user's hair.

A magnetic mount 44 is coupled to the clip bottom 24. The magnetic mount 44 may be coupled to the clip bottom inner side 32 proximal the clip bottom back end 26. The magnetic mount 44 may be circular and may have a raised, arc-shaped ridge 45. A ferrous ball marker 46 is selectively engageable with the magnetic mount 44. The ball marker 46 may conform to the dimensions of the magnetic mount 44.

In use, the apparatus 10 is clipped to the user's hat 40 and with the clip bottom 24 against the user's head. When needed for use to repair a divot, the user squeezes the back portion 34 to remove the apparatus 10 and apply the clip top front end 16 to the divot. The ball marker 46 may be removed as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A golf clip multi-tool apparatus comprising:
a clip top having a clip top back end, a clip top front end, a clip top outer side, and a clip top inner side, the clip top front end being pointed and configured for use as a divot repair tool;
a clip bottom having a clip bottom back end, a clip bottom front end, a clip bottom outer side, and a clip bottom inner side, the clip bottom being curved such that the clip bottom is configured to conform to the curvature of the user's head from the user's temple towards the top of the user's head, the clip bottom front end being pointed and configured for use with the clip top as a divot repair tool;
a pivot rod coupled to the clip top and the clip bottom, the pivot rod being pivotably coupled to a pair of pivot ears of each of the clip top inner side and the clip bottom inner side proximal the clip top back end and the clip bottom back end, respectively, the clip top and the clip bottom pivoting between an open position with the clip top back end adjacent the clip bottom back end and a closed position with the clip top inner side adjacent the clip bottom inner side;
a pivot spring coupled around the pivot rod, the pivot spring contacting the clip top inner side and the clip bottom inner side to bias the clip top and the clip bottom to the closed position;
a magnetic mount coupled to the clip bottom, the magnetic mount being positioned on the clip bottom inner side between the clip bottom back end and the pivot rod wherein the magnetic mount is positioned opposite the clip top inner side between the clip top back end and the pivot rod; and
a ferrous ball marker being selectively engageable with the magnetic mount.

2. The golf clip multi-tool apparatus of claim 1 further comprising the clip top having a stencil aperture extending from the clip top outer side through the clip top inner side, the stencil aperture being configured to be positioned over a golf ball and to receive a marker to create an identification mark on the golf ball.

3. The golf clip multi-tool apparatus of claim 2 further comprising the stencil aperture being an elongated obround shape.

4. The golf clip multi-tool apparatus of claim 1 thither comprising the clip top having a back portion and a front portion, the back portion being planar and extending from the clip top back end to the pivot ears of the clip top inner side and the front portion extending from the back portion to the clip top front end and having a curvature conforming to the curvature of the clip bottom.

5. (canceled)

6. The golf clip multi-tool apparatus of claim 1 further comprising the magnetic mount being circular and coupled proximal the clip top back end, the ball marker conforming to the dimensions of the magnetic mount.

7. The golf clip multi-tool apparatus of claim 1 further comprising a bottle opener tab coupled to the clip top, the bottle opener end being coupled to the clip top outer side and being configured to open bottles.

8. A golf clip multi-tool apparatus comprising:
a clip top having a clip top back end, a clip top front end, a clip top outer side, and a clip top inner side, the clip top front end being pointed and configured for use as a divot repair tool, the clip top having a stencil aperture extending from the clip top outer side through the clip top inner side, the stencil aperture being an elongated obround shape configured to be positioned over a golf ball and to receive a marker to create an identification mark on the golf ball;
a bottle opener tab coupled to the clip top, the bottle opener end being coupled to the clip top outer side and being configured to open bottles;
a clip bottom having a clip bottom back end, a clip bottom front end, a clip bottom outer side, and a clip bottom inner side, the clip bottom being curved such that the clip bottom is configured to conform to the curvature of the user's head from the user's temple towards the top of the user's head, the clip bottom front end being pointed and configured for use with the clip top as a divot repair tool;
a pivot rod coupled to the clip top and the clip bottom, the pivot rod being pivotably coupled to a pair of pivot ears of each of the clip top inner side and the clip bottom inner side proximal the clip top back end and the clip bottom back end, respectively, the clip top and the clip bottom pivoting between an open position with the clip top back end adjacent the clip bottom back end and a closed position with the clip top inner side adjacent the clip bottom inner side, the clip top having a back portion and a front portion, the back portion being planar and extending from the clip top back end to the pivot ears of the clip top inner side and the front portion extending from the back portion to the clip top front end, the clip top front portion having a curvature conforming to the curvature of the clip bottom;
a pivot spring coupled around the pivot rod, the pivot spring contacting the clip top inner side and the clip bottom inner side to bias the clip top and the clip bottom to the closed position;
a magnetic mount coupled to the clip bottom, the magnetic mount being positioned on the clip bottom inner side between the clip bottom back end and the pivot rod wherein the magnetic mount is positioned opposite the clip top inner side between the clip top back end and the pivot rod; and
a ferrous ball marker, the ball marker being selectively engageable with the magnetic mount, the ball marker conforming to the dimensions of the magnetic mount.
